(19) United States
(12) Patent Application Publication
(10) Pub. No.: US 2016/0072149 A1
(43) Pub. Date: Mar. 10, 2016

(54) AN ELECTRODE PLATE, A METHOD FOR FORMING THE ELECTRODE PLATE, AND A METHOD FOR FORMING A LITHIUM BATTERY CORE CONTAINING ELECTRODE PLATE

(71) Applicant: JORDAN GREEN TECHNOLOGY(DG) CO., LTD., Guangdong (CN)

(72) Inventor: Wenhong Huang, Guangdong (CN)

(21) Appl. No.: 14/783,649

(22) PCT Filed: Jul. 29, 2013
(86) PCT No.: PCT/CN2013/080286

§ 371 Date: Oct. 9, 2015

(51) Int. Cl. H01M 10/0565; H01M 10/0587; H01M 10/0525; H01M 10/0585; H01M 4/04; H01M 4/13

(52) U.S. Cl. CPC H01M 10/0565; H01M 4/0402; H01M 4/13; H01M 10/0525; H01M 10/0585; H01M 10/0587; H01M 2004/027

(57) ABSTRACT

An electrode plate having a front surface a large proportion of which is coated with a first coating layer and a back surface a large proportion of which is combined with a second coating layer. The first and second coating layers are respectively combined with a solid-state molecular polyelectrolyte coating layer. The electrode plate is used as a positive electrode plate or negative electrode plate, and the positive and negative electrode plates are alternatively stacked. A solid-state molecular polyelectrolyte coating layer is located between the positive and negative electrode plates. A winding core is formed by alternatively stacking and continuously winding the positive and negative electrode plates, and the formed winding core is used to form a Lithium battery core. The formed Lithium battery core can operate normally under high-temperature and low-temperature environments and has stable performance, so as to ensure a safety use.

### BACKGROUND OF THE INVENTION

1. Field of Invention

The present invention relates to an electrode plate, a method for forming the electrode plate, and a method for forming a Lithium battery core containing the electrode plate, and more particularly, to an electrode plate that has stable performance both under low-temperature and high-temperature environments so as to ensure the safety of use, and a method for forming the electrode plate, and a method for forming a Lithium battery core containing the electrode plate.

2. Prior Art

Lithium battery cores have been developed at a high speed in certain fields during recent years because they are light in weight, have much higher safety coefficient than steel-casing or aluminum-casing batteries, and are not liable to explosion. However, actually, these Lithium battery cores are only liquid-state Lithium battery cores packaged in different cases. When these battery cores are in states of charging, discharging, or short-circuiting, or under high-temperature environment, the temperature of battery electrolyte solution would be raised up to 75-80° C. or even higher. Under such high-temperature environment, organic solvents (like dimethyl carbonate, DMC) or some impurity in the electrolyte solution would produce certain kinds of gas, such as hydrogen gas, oxygen gas, or carbon dioxide, which would result in bloating phenomenon and cause leakage of the fluid. In this case, not only the performance of the battery cores would be affected, it would be also liable to the potential risk of explosion.

Moreover, the processes for manufacturing the electrode plates of the Lithium battery cores are generally classified into two types: stacking type and winding type. In these two types, positive electrode plates and negative electrode plates are repeatedly stacked or wound only after separating papers are placed between these positive electrode plates and negative electrode plates. The stacked or wound plates are then placed into a case, electrolyte fluid is filled into the case, and finally the case is proceeded with ball sealing, so as to form a Lithium battery core. However, both of the separating papers and electrolyte fluid have poor tolerance to low temperature and high temperature. Accordingly, the Lithium battery core would have a potential risk of bloating and explosion when the temperature of the battery electrolyte fluid is increased up to 75-80° C. or even higher temperature. In addition, the Lithium battery core also would fail to work under low temperature environment.

In view of above problems, in order to overcome these drawbacks, the present invention is aimed at overcoming the limitation on the operation of the conventional electrode plates and the Lithium battery cores containing the convention electrode plates under high or low temperature environment, and thus providing the battery core with more stable performance so as to ensure a safety use.

### SUMMARY OF THE INVENTION

An object of the present invention is to provide an electrode plate, a method for forming the electrode plate, and a method for forming a Lithium battery core containing the electrode plate, where the electrode plate has two surfaces each of which is combined with a solid-state molecular polyelectrolyte coating layer that has properties of electric conductivity and good tolerance to high and low temperature. Thereby, it not only could prevent the problems of bloating and fluid leakage when the electrode plate and the Lithium battery core containing the electrode plate are used under high temperature environment, but it also could ensure normal operation of the electrode plate and the Lithium battery core containing the electrode plate when they are operated under low temperature environment.

In order to achieve the above-mentioned object, the present invention provides an electrode plate having a front surface and a back surface, where a large proportion of the front surface of the electrode plate is combined with a first coating layer, a large proportion of the back surface of the electrode plate is combined with a second coating layer, and the first and the second coating layers are respectively corresponding to the front and the back surfaces of the electrode plate; said electrode plate characterized in that: the first coating layer and the second coating layer are respectively combined with a solid-state molecular polyelectrolyte coating layer.

In implementation, the solid-state molecular polyelectrolyte coating layer is made by a high-molecular polymer that has a repeating unit E¹ represented by following Formula I:

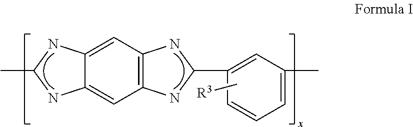

Where the repeating unit E¹ has two side groups L¹ and L² that are bonded with two of the four nitrogen atoms in the repeating unit E¹, where:
L¹ and L² independently represent a R¹—SO₃M group, in which
R¹ represents a hydrocarbon,
M represents a cation selected from the group consisting of Li⁺, Na⁺, H⁺, and K⁺,
R³ represents a H group or a SO₃M group, and
x represents an integer greater than 10.

The present invention also provides a method for forming the electrode plate comprising steps of: a. coating a solid-state molecular polyelectrolyte coating layer respectively onto a first coating layer located on a front surface of the electrode plate and a second coating layer located on a back surface of the electrode plate; and b. drying the solid-state molecular polyelectrolyte coating layer, so as to have the solid-state molecular polyelectrolye coating layer firmly attached onto the first coating layer and the second coating layer respectively.

In implementation, the method for forming the electrode plate further comprises a step of: applying an insulating adhesive respectively onto the front surface and the back surface of the electrode plate, and the insulating adhesive is located at one lateral side of the respective solid-state molecular polyelectrolye coating layer on the front surface and the back surfaces of the electrode plate.

The present invention also provides a method for forming a Lithium battery core comprising steps of: a. cutting positive electrode plates and negative electrode plates each of which is coated with a solid-state molecular polyelectrolyte coating layer, so as to provide each positive electrode plate with a positive tab and each negative electrode plate with a negative tab; b. alternatively stacking the positive electrode plates and the negative electrode plates; c. positioning the positive electrode plates and the negative electrode plates, connecting the positive tabs of the positive electrode plates, and connecting the negative tabs of the negative electrode plates; d. connecting each positive tab to the positive electrode plate of the cover plate, and connecting each negative tab to the negative electrode plate of the cover plate; e. placing the positive electrode plates and the negative electrode plates into the case; and f. connecting the case with the cover plate, so as to form the Lithium battery core.

The present invention also provides another method for forming a Lithium battery core comprising steps of; a. cutting positive electrode plates and negative electrode plates each of which is coated with a solid-state molecular polyelectrolyte coating layer, so as to provide each positive electrode plate with a positive tab and each negative electrode plate with a negative tab; b. alternatively stacking the positive electrode plates and the negative electrode plates, winding the alternatively-stacked positive electrode plates and the negative electrode plates continuously to form a winding core, and placing an insulating sheet within the winding core; c. positioning the positive electrode plates and the negative electrode plates, connecting the positive tabs of the positive electrode plates, and connecting the negative tabs of the negative electrode plates; d. connecting each positive tab to the positive electrode plate of the cover plate, and connecting each negative tab to the negative electrode plate of the cover plate; e. placing the winding core into the case; and f. connecting the case with the cover plate, so as to form the Lithium battery core.

The present invention will become more fully understood by reference to the following detailed description thereof when read in conjunction with the attached drawings.

### BRIEF DESCRIPTION OF THE DRAWINGS

FIGS. 1 and 2 are cross-sectional perspective views showing a preferred embodiment of an electrode plate according to the present invention.

FIG. 3 is a perspective view showing alternatively stacked positive and negative electrode plates according to the present invention.

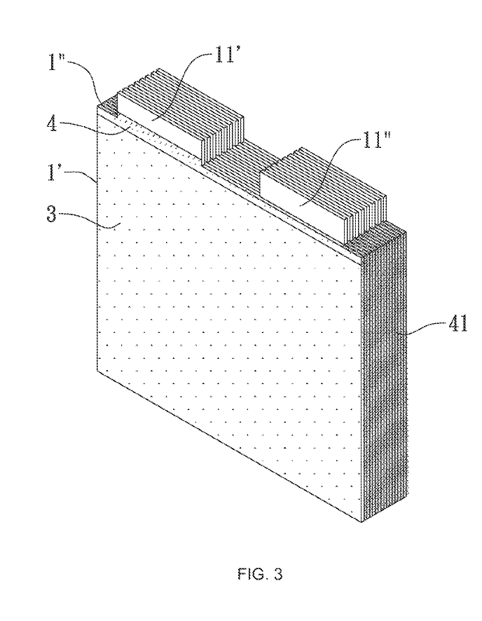

FIG. 4 is a perspective view showing positive and negative electrode plates that are bound and positioned by using a self-adhesive tape according to the present invention.

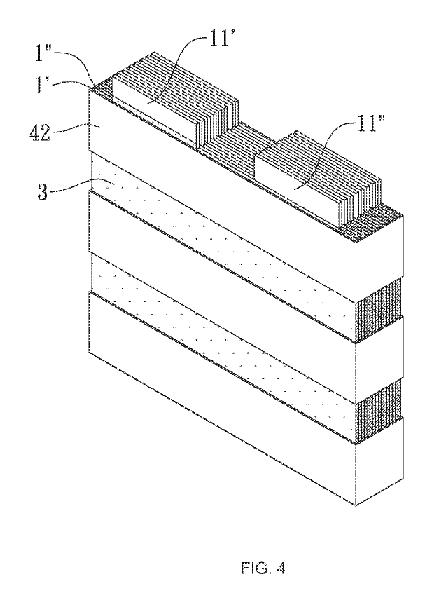

FIG. 5 is an exploded view showing elements of a stacking-type Lithium battery core prior to the assembly process according to the present invention.

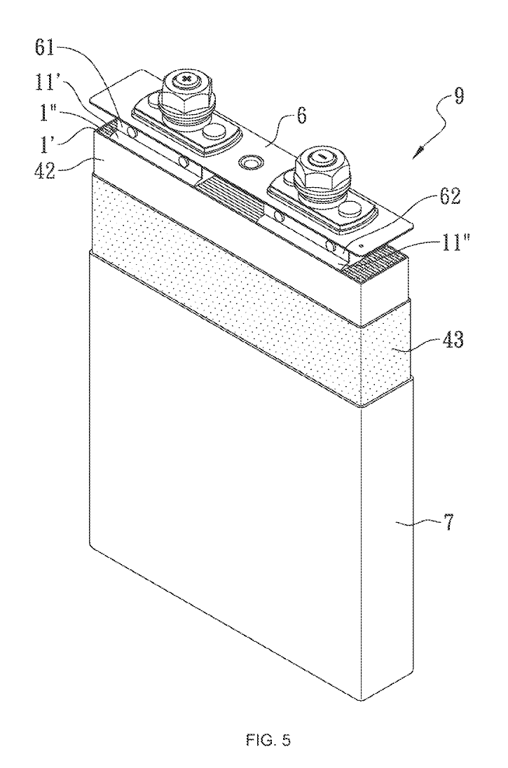

FIG. 6 is a perspective view showing the stacking-type Lithium battery core after the assembly process according to the present invention.

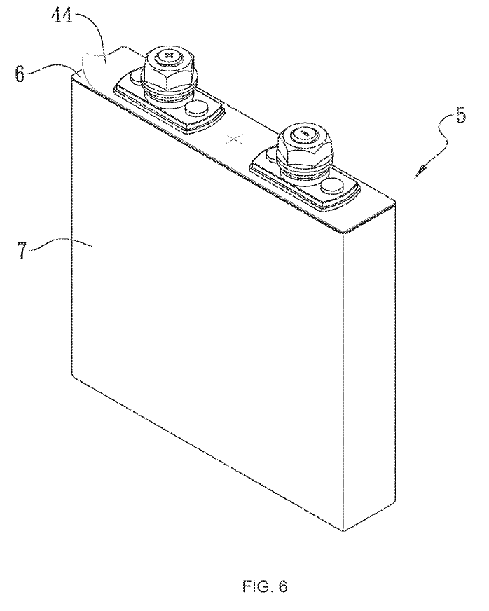

FIG. 7 is a perspective view showing a winding core formed by winding positive and negative electrode plates according to the present invention.

FIG. 8 is a perspective view showing positive and negative electrode plates that are bound and positioned by using a self-adhesive tape according to the present invention

FIG. 9 is a perspective view showing the winding core that has a bottom coated with an insulating adhesive according to the present invention.

FIG. 10 is an exploded view showing elements of a winding-type Lithium battery core prior to the assembly process according to the present invention.

### DETAILED DESCRIPTION OF THE INVENTION

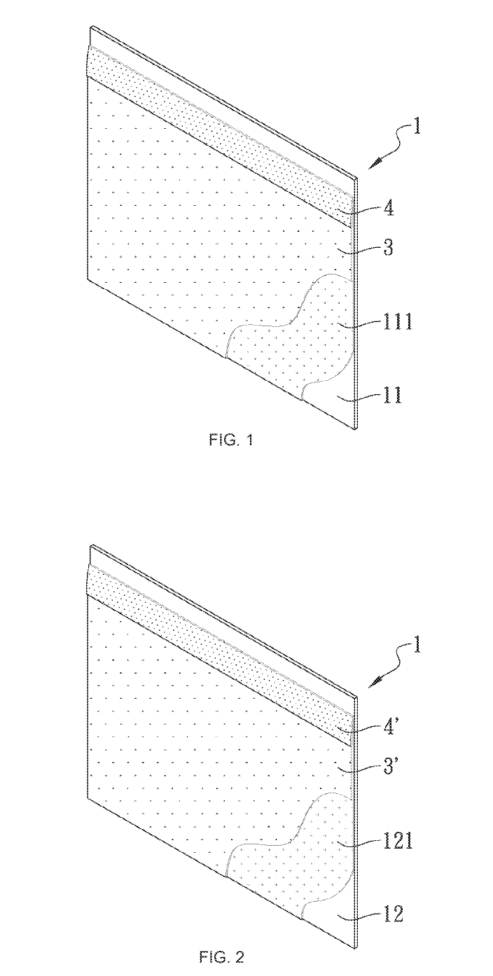

Please refer to FIGS. 1 and 2, which show a preferable embodiment of an electrode plate 1 according to the present invention. The electrode plate 1 is used as one of a positive electrode plate and a negative electrode plate. The electrode plate has a front surface 11 and a back surface 12. A large proportion of the front surface 11 of the electrode plate 1 is combined with a first coating layer 111, while other area of the front surface 11 of the electrode plate 1 is generally in an elongate shape. A large proportion of the back surface 12 of the electrode plate 1 is combined with a second coating layer 121, while other area of the back surface 12 of the electrode plate 1 is generally in an elongate shape. Thereby, the first and the second coating layers (111, 121) are respectively corresponding to the front and the back surfaces (11, 12) of the electrode plate 1. Moreover, a solid-state molecular polyelectrolyte coating layer (3, 3′) is respectively attached to external surfaces of the first coating layer 111 and the second coating layer 121.

In the case that the electrode plate 1 is used as a positive electrode plate, the first and the second coating layers (111, 121) are made by Lithium mixed metal oxide selected from: LiMnO₂ [symbol] LiMn₂O₄ [symbol] LiCoO₂ [symbol] Li₂Cr₂O₇ [symbol] Li₂CrO4 [symbol] LiNiO₂ [symbol] LiFeO₂ [symbol] LiNiₓCo₁₋ₓO₂ [symbol] LiFePO₄ [symbol] LiMn_{0.5}Ni_{0.5}O₂ [symbol] LiMn_{1/3}Co_{1/3}Ni_{1/3}O₂ [symbol] Mc_{0.5}Mn_{1.5}O₄ and combinations thereof. In the case that the electrode plate 1 is used as a negative electrode plate, the first and the second coating layers (111, 121) are formed by grinding commercial spherical mass of silicon power and covering the silicon material with a carbon film.

The solid-state molecular polyelectrolyte coating layers (3, 3′) are made by high-molecular polymers having good tolerance both to high temperature and low temperature. In the present embodiment, each solid-state molecular polyelectrolyte coating layer (3, 3′) has a repeating unit E¹ represented by following Formula I:

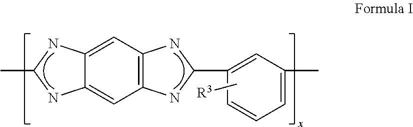

The repeating unit E¹ has two side groups L¹ and L² that are bonded with two of the four nitrogen atoms in the repeating unit E¹, wherein:
L¹ and L² independently represent a R¹—SO₃M group, in which
R¹ represents a hydrocarbon,
M represents a cation selected from the group consisting of Li⁺, Na⁺, H⁺, and K⁺,
R³ represents a H group or a SO₃M group, and
x represents an integer greater than 10.

Experimental results show that, under room temperature, the three-dimensional isotropic electrical conductivity of the solid-state molecular polyelectrolyte coating layers (3, 3′) is about 2.8×10⁻³ S/cm.

In implementation, the method for forming the above-mentioned electrode plate 1 comprises steps of:
a. coating the solid-state molecular polyelectrolyte coating layer (3, 3′) respectively onto the first coating layer 111 located on the front surface 11 of the electrode plate 1 and the second coating layer 121 located on the back surface 12 of the electrode plate 1; and
b. drying the solid-state molecular polyelectrolyte coating layer (3, 3′), so as to have the solid-state molecular polyelectrolye coating layer (3, 3′) firmly attached onto the first coating layer 111 and the second coating layer 121 respectively.

In step a, the solid-state molecular polyelectrolyte coating layer (3, 3′) could be dissolved in many kinds of protic solvents (such as dimethyl sulfoxide or dimethyl formamide) or dissolved in water before being coated unto the first and the second coating layers (111, 121). The step a is followed by another step of: applying an insulating adhesive (4, 4′) respectively onto the front surface 11 and the back surface 12 of the electrode plate 1, and the insulating adhesive (4, 4′) is located at one lateral side of the respective solid-state molecular polyelectrolye coating layers (3, 3′) on the front surface 11 and the back surfaces 12 of the electrode plate 1.

Please refer to FIGS. 1˜6, which show a first embodiment of a method for forming a Lithium battery core 5 containing the above-mentioned electrode plate 1. This method is of stacking type and mainly comprises steps of:
a. cutting positive electrode plates 1′ and negative electrode plates 1″ that are coated with the solid-state molecular polyelectrolyte coating layer (3, 3′), so as to provide each positive electrode plate 1′ with a positive tab 11′ and each negative electrode plate 1″ with a negative tab 11″;
b. alternatively stacking the positive electrode plates 1′ and the negative electrode plates 1″;
c. positioning the positive electrode plates 1′ and the negative electrode plates 1″, connecting the positive tabs 11′ of the positive electrode plates 1′, and connecting the negative tabs 11″ of the negative electrode plates 1″;
d. connecting each positive tab 11′ to a positive electrode plate 61 of a cover plate 6, and connecting each negative tab 11″ to a negative electrode plate 62 of the cover plate 6;
e. placing the positive electrode plates 1′ and the negative electrode plates 1″ into a case 7; and
f. connecting the case 7 with the cover plate 6, so as to form the Lithium battery core 9.

After step b, an insulating adhesive 41 is applied onto peripheries of each positive electrode plate 1′ and each negative electrode plate 1″ in order to prevent short-circuiting. In step c, a self-adhesive tape 42 that has good tolerance to high temperature is used to bind the positive electrode plates 1′ and the negative electrode plates 1″ in order to position these plates. After step d, an insulating plastic bag 43 is used to wrap the positive electrode plates 1′ and the negative electrode plates 1″. After step f, an insulating sheet 44 is attached onto the top of the cover plate 6. Finally, the case is evacuated and sealed, so as to form the Lithium battery core 9.

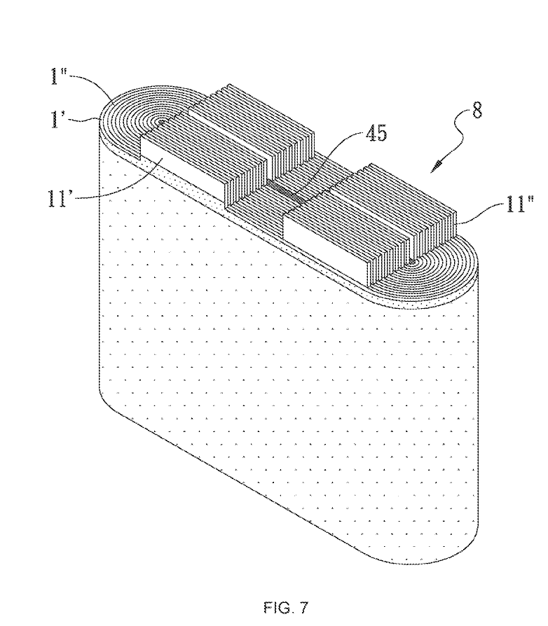

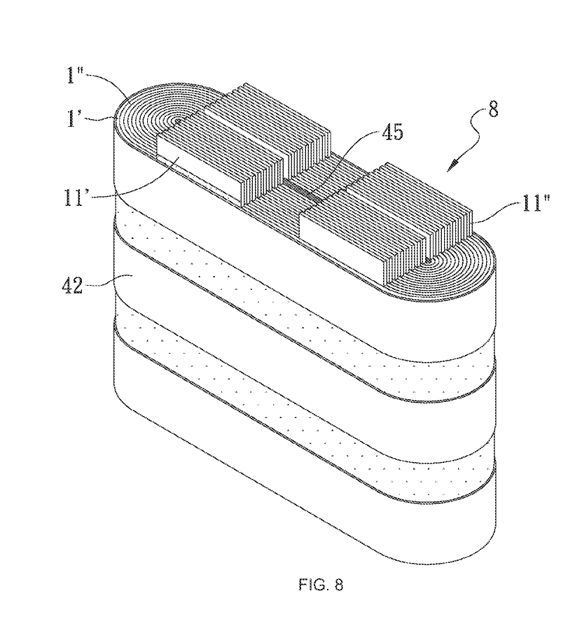

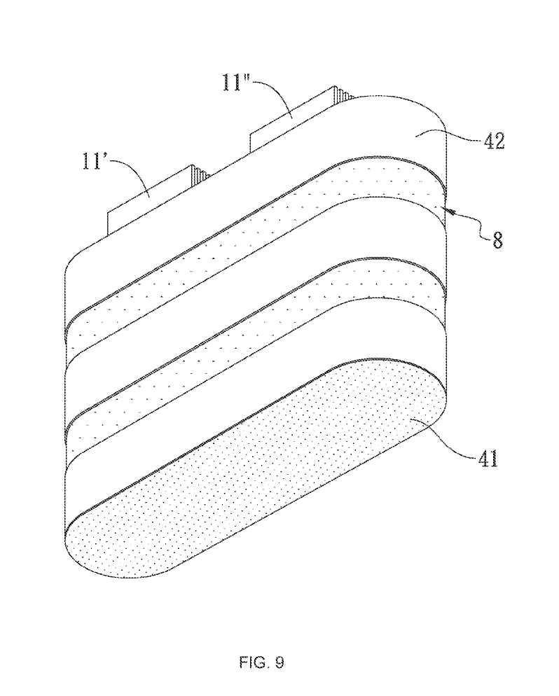

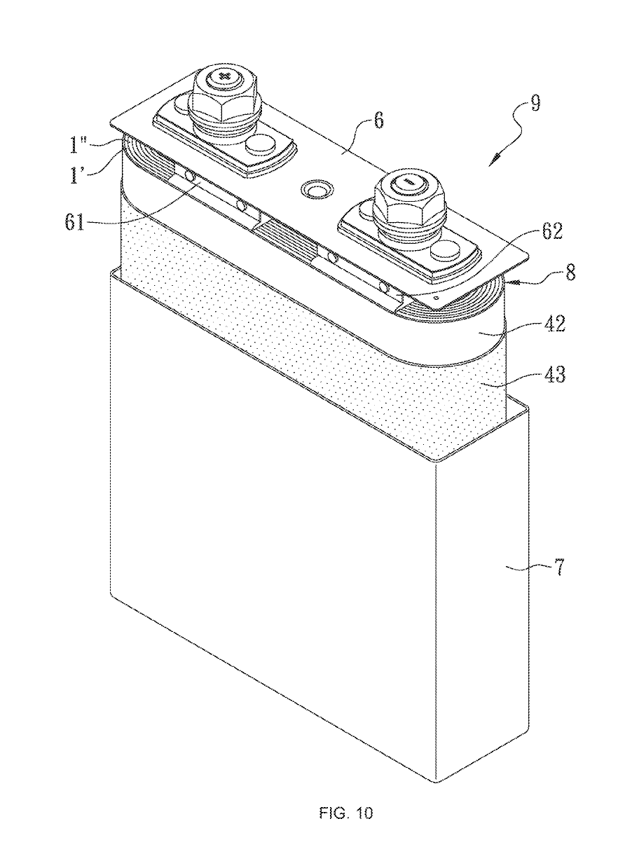

Please refer to FIGS. 7-10, which show a second embodiment of a method for forming a Lithium battery core 9 containing the above-mentioned electrode plate 1. This method is of winding type and mainly comprises steps of:
a. cutting positive electrode plates 1′ and negative electrode plates 1″ that are coated with the solid-state molecular polyelectrolyte coating layer (3, 3′), so as to provide each positive electrode plate 1 with a positive tab 11′ and each negative electrode plate 1″ with a negative tab 11″;
b. alternatively stacking the positive electrode plates 1′ and the negative electrode plates 1″, winding the alternatively-stacked plates continuously to form a winding core 8, and placing an insulating sheet 45 within the winding core 8;
c. positioning the positive electrode plates 1′ and the negative electrode plates 1″, connecting the positive tabs 11′ of the positive electrode plates 1′, and connecting the negative tabs 11″ of the negative electrode plates 1″;
d. connecting each positive tab 11′ to the positive electrode plate 61 of the cover plate 6, and connecting each negative tab 11″ to the negative electrode plate 62 of the cover plate 6;
e. placing the winding core 8 into the case 7; and
f. connecting the case 7 with the cover plate 6, so as to form the Lithium battery core 9.

After step b, a self-adhesive tape 42 having good tolerance to high temperature is used to bind and position the winding core 8 and an insulating adhesive 41 is applied onto the bottom of the winding core 8 in order to prevent short-circuiting. After step d, an insulating plastic bag 43 is used to wrap the positive electrode plates 1′ and the negative electrode plates 1″. After step f, an insulating sheet 44 is attached onto the top of the cover plate 6. Finally, the case is evacuated and sealed, so as to form the Lithium battery core 9.

Therefore, the present invention has the following advantages:

1. According to the present invention, the solid-state molecular polyeletrolyte coating layer is directly applied and attached onto two sides of the electrode plate, without the need of using separating paper or electrolyte fluid. Thereby, it is able to increase the working efficiency and decrease the cost both of manufacturing and assembling.

2. According to the present invention, the solid-state molecular polyeletrolyte coating layer is directly applied and attached onto two sides of the electrode plate, without the need of using separating paper or electrolyte fluid. Thereby, it is not only able to prevent the occurrence of the problems of bloating or liquid leakage and ensure a safety use under high temperature environment, but it also able to keep the operation normal under low temperature environment.

3. The electrode plate according to the present invention is suitable for a variety of shapes of Lithium battery cores, such as rectangular rigid or cylindrical cases. Besides, it is also suitable both for stacking-type and winding-type Lithium battery cores. Thereby, it has widespread use in the field.

Therefore, according to above-disclosed descriptions, the present invention can achieve the expected object to provide an electrode plate, a method for forming the electrode plate, and a method for forming a Lithium battery core containing the electrode plate, by which it is able to overcome the limitation on the application environment for batteries, to prevent the occurrence of the problems of bloating and fluid leakage, to provide the batteries with stable performance, and to ensure a safety use. It is novel and has industrial use.

1. An electrode plate, having a front surface and a back surface, where a large proportion of the front surface of the electrode plate is combined with a first coating layer, a large proportion of the back surface of the electrode plate is combined with a second coating layer, and the first and the second coating layers are respectively corresponding to the front and the back surfaces of the electrode plate; said electrode plate characterized in that:
the first coating layer and the second coating layer are respectively combined with a solid-state molecular polyelectrolyte coating layer,
wherein the solid-state molecular polyelectrolyte coating layer is made by a high-molecular molecular polymer that has a repeating unit E¹ represented by following Formula I: 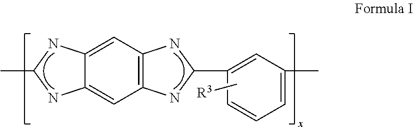
the repeating unit E¹ has two side groups L¹ and L² that are bonded with two of the four nitrogen atoms in the repeating unit E¹, wherein:
L¹ and L² independently represent a R¹—SO₃M group, in which
R¹ represents a hydrocarbon,
M represents a cation selected from the group consisting of Li⁺, Na⁺, H⁺, and K⁺,
R³ represents a H group or a SO₃M group, and
x represents an integer greater than 10.

2. (canceled)

3. A method for forming the electrode plate as claimed in claim 1, comprising steps of:
a. coating a solid-state molecular polyelectrolyte coating layer respectively onto a first coating layer located on a front surface of the electrode plate and a second coating layer located on a back surface of the electrode plate, wherein the solid-state molecular polyelectrolyte coating layer is made by a high-molecular molecular polymer that has a repeating unit E¹ represented by following Formula I: 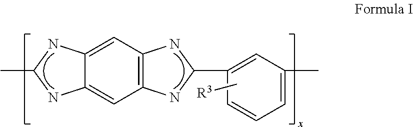
the repeating unit E¹ has two side groups L¹ and L² that are bonded with two of the four nitrogen atoms in the repeating unit E¹, wherein:
L¹ and L² independently represent a R¹—SO₃M group, in which
R¹ represents a hydrocarbon,
M represents a cation selected from the group consisting of Li⁺, Na⁺, H⁺, and K⁺,
R³ represents a H group or a SO₃M group, and
x represents an integer greater than 10; and
b. drying the solid-state molecular polyelectrolyte coating layer, so as to have the solid-state molecular polyelectrolye coating layer firmly attached onto the first coating layer and the second coating layer respectively.

4. (canceled)

5. The method as claimed in claim 3, further comprising a step of: applying an insulating adhesive respectively onto the front surface and the back surface of the electrode plate, and the insulating adhesive is located at one lateral side of each of the solid-state molecular polyelectrolye coating layers on the front and the back surfaces of the electrode plate.

6. A method for forming a Lithium battery core containing the electrode plate as claimed in claim 1, where the electrode plate is used as a positive electrode plate or as a negative electrode plate, the Lithium battery core comprises a case and a cover plate, and the cover plate is provided with a positive electrode plate and a negative electrode plate; said method for forming the Lithium battery core comprising steps of:
a. cutting positive electrode plates and negative electrode plates each of which is coated with a solid-state molecular polyelectrolyte coating layer, so as to provide each positive electrode plate with a positive tab and each negative electrode plate with a negative tab;
b. alternatively stacking the positive electrode plates and the negative electrode plates;
c. positioning the positive electrode plates and the negative electrode plates, connecting the positive tabs of the positive electrode plates, and connecting the negative tabs of the negative electrode plates;
d. connecting each positive tab to the positive electrode plate of the cover plate, and connecting each negative tab to the negative electrode plate of the cover plate;
e. placing the positive electrode plates and the negative electrode plates into the case; and
f. connecting the case with the cover plate, so as to form the Lithium battery core.

7. The method as claimed in claim 6, further comprising a step of: applying an insulating adhesive onto peripheries of each positive electrode plate and each negative electrode plate, and using an adhesive tape to fix each positive electrode plate and each negative electrode plate.

8. A method for forming a Lithium battery core containing the electrode plate as claimed in claim 1, where the electrode plate is used as a positive electrode plate or as a negative electrode plate, the Lithium battery core comprises a case and a cover plate, and the cover plate is provided with a positive electrode plate and a negative electrode plate; said method for forming the Lithium battery core comprising steps of:
a. cutting positive electrode plates and negative electrode plates each of which is coated with a solid-state molecular polyelectrolyte coating layer, so as to provide each positive electrode plate with a positive tab and each negative electrode plate with a negative tab;
b. alternatively stacking the positive electrode plates and the negative electrode plates, winding the alternatively-stacked positive electrode plates and the negative electrode plates continuously to form a winding core, and placing an insulating sheet within the winding core;
c. positioning the positive electrode plates and the negative electrode plates, connecting the positive tabs of the positive electrode plates, and connecting the negative tabs of the negative electrode plates;
d. connecting each positive tab to the positive electrode plate of the cover plate, and connecting each negative tab to the negative electrode plate of the cover plate;
e. placing the winding core into the case; and
f. connecting the case with the cover plate, so as to form the Lithium battery core.

9. The method as claimed in claim 8, further comprising a step of: using an adhesive tape to fix the winding core and applying an insulating adhesive onto the winding core's bottom.

10. The method as claimed in claim 6, further comprising steps of:
using an insulating plastic bag to wrap the positive electrode plates and the negative electrode plates; and
attaching an insulating sheet onto the cover plate's top, and evacuating and sealing the case.

11. The method as claimed in claim 8, further comprising steps of:
using an insulating plastic bag to wrap the positive electrode plates and the negative electrode plates; and
attaching an insulating sheet onto the cover plate's top, and evacuating and sealing the case.
